(19) United States
(12) Patent Application Publication
(10) Pub. No.: US 2019/0116742 A1
(43) Pub. Date: Apr. 25, 2019

(54) Canopy Sprinkler Assembly

(71) Applicant: Patricia Denton, Alton, IL (US)

(72) Inventor: Patricia Denton, Alton, IL (US)

(21) Appl. No.: 15/792,390

(22) Filed: Oct. 24, 2017

(51) Int. Cl. A01G 25/02; B05B 1/20; B05B 15/06; A01G 13/02

(52) U.S. Cl. CPC A01G 25/02; B05B 1/202; A01G 13/0206; B05B 15/063; B05B 1/205

(57) ABSTRACT

A canopy sprinkler assembly includes a frame that is substantially hollow. The frame is fluidly coupled to a fluid source thereby facilitating the frame to selectively spray a fluid. A stand is provided and the stand is selectively positioned on a support surface. The frame is coupled to the stand such that the frame is elevated from the support surface. Moreover, the stand is selectively positioned around a garden thereby facilitating the frame to selectively irrigate the garden. A canopy is removably positioned on the frame such that the canopy completely covers the frame. The canopy is comprised of an opaque material to shade the garden.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to sprinkler devices and more particularly pertains to a new sprinkler device for selectively irrigating a garden.

### BRIEF SUMMARY OF THE INVENTION

An embodiment of the disclosure meets the needs presented above by generally comprising a frame that is substantially hollow. The frame is fluidly coupled to a fluid source thereby facilitating the frame to selectively spray a fluid. A stand is provided and the stand is selectively positioned on a support surface. The frame is coupled to the stand such that the frame is elevated from the support surface. Moreover, the stand is selectively positioned around a garden thereby facilitating the frame to selectively irrigate the garden. A canopy is removably positioned on the frame such that the canopy completely covers the frame. The canopy is comprised of an opaque material to shade the garden.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than conduit set forth above will become apparent when consideration is given to the following detailed description thereof. Such description makes reference to the annexed drawings wherein:

FIG. 1 is a top perspective view of a canopy sprinkler assembly according to an embodiment of the disclosure.

FIG. 2 is a phantom perspective view of an embodiment of the disclosure.

FIG. 3 is a right side view of an embodiment of the disclosure.

FIG. 4 is a perspective in-use view of an embodiment of the disclosure.

FIG. 5 is a cross sectional view taken along line 5-5 of FIG. 2 of an embodiment of the disclosure.

FIG. 6 is a cross sectional view taken along line 6-6 of FIG. 3 of an embodiment of the disclosure.

### DETAILED DESCRIPTION OF THE INVENTION

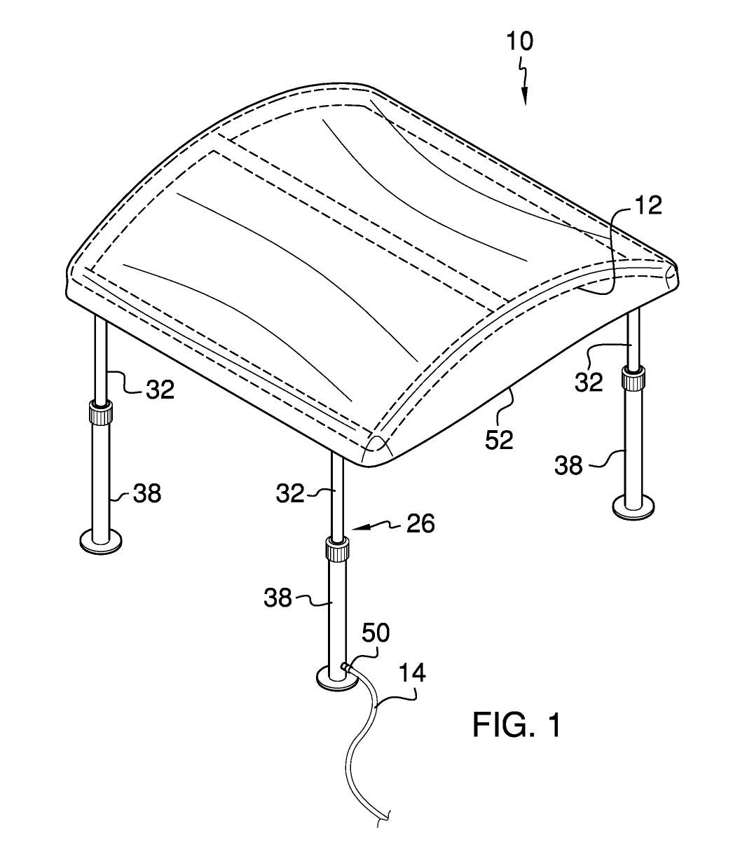

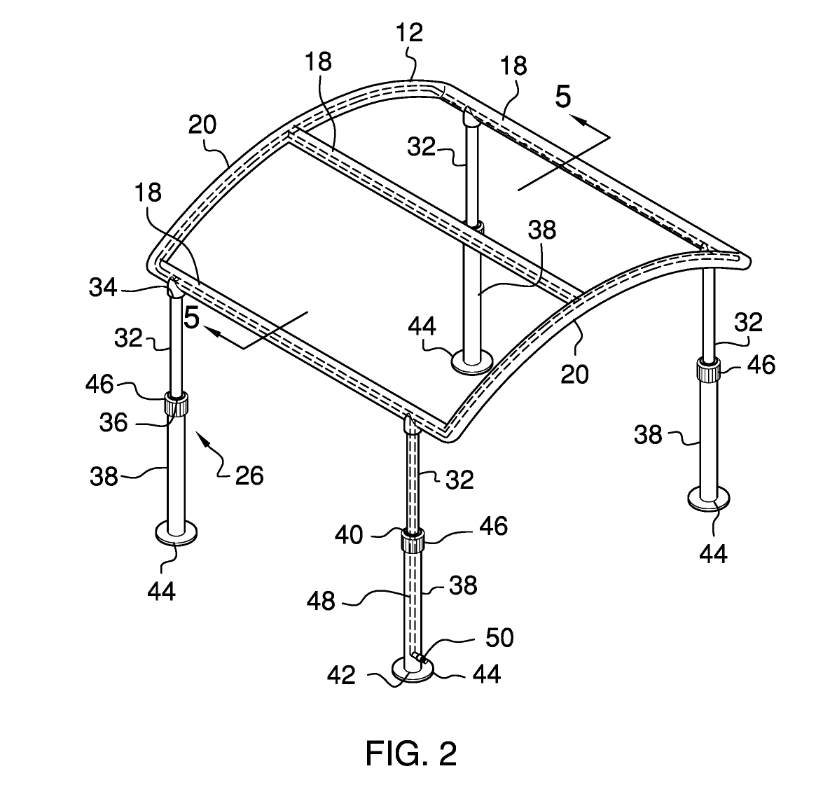

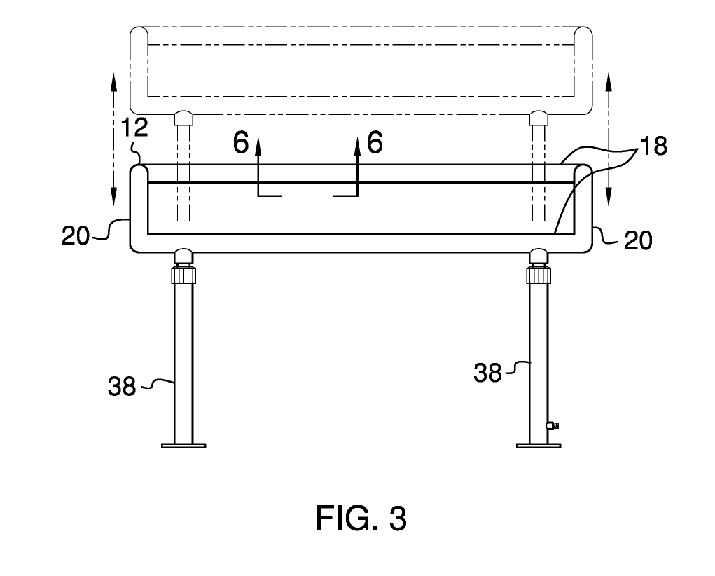

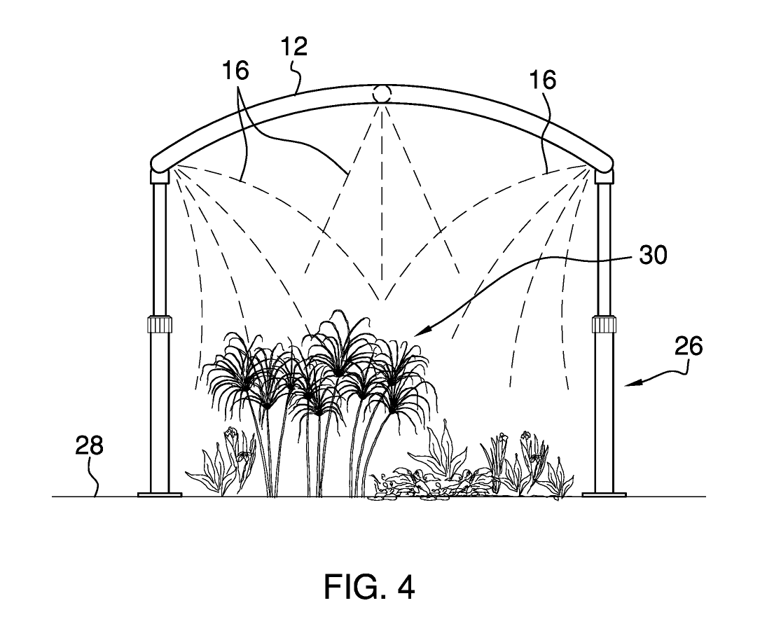

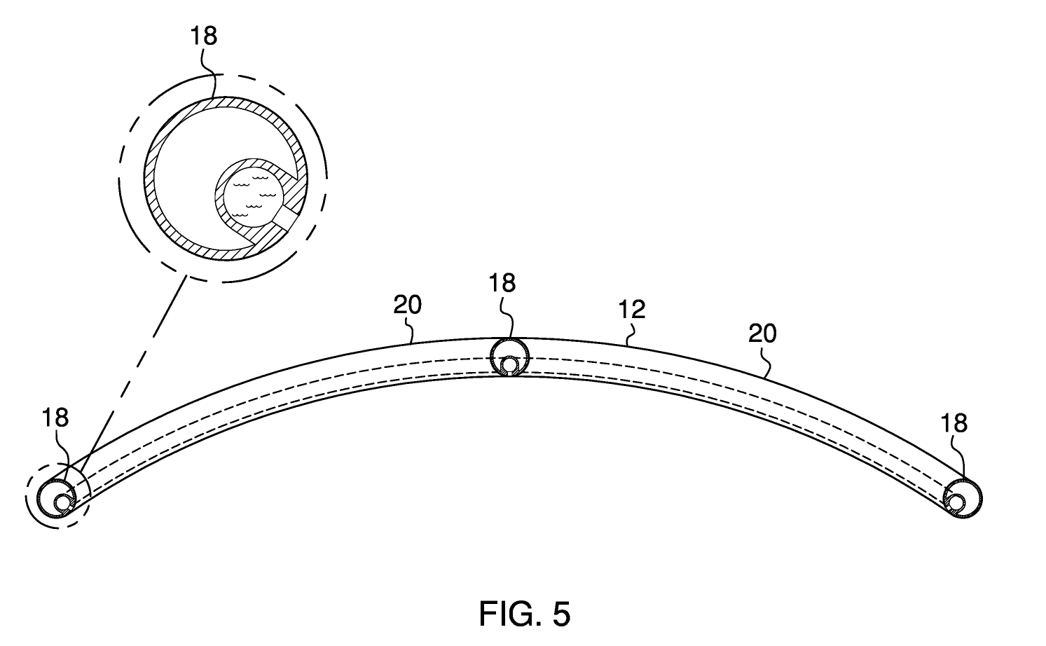

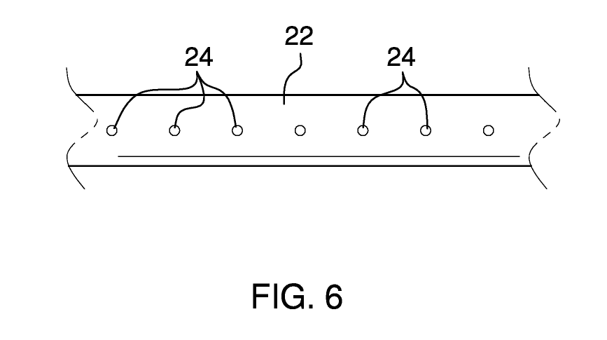

With reference now to the drawings, and in particular to FIGS. 1 through 6 thereof, a new sprinkler device embodying the principles and concepts of an embodiment of the disclosure and generally designated by the reference numeral 10 will be described.

As best illustrated in FIGS. 1 through 6, the canopy sprinkler assembly 10 generally comprises a frame 12 that is substantially hollow. The frame 12 is fluidly coupled to a fluid source 14 thereby facilitating the frame 12 to selectively spray a fluid 16. The fluid source 14 may be a garden hose or the like and the fluid 16 may be water. The frame 12 has a plurality of longitudinal members 18 each extending between a pair of lateral members 20. The lateral members 20 are spaced apart from each other such that the frame 12 has a rectangular shape. Additionally, the longitudinal members 18 are spaced apart from each other along the lateral members 20.

Each of the lateral members 20 is concavely arcuate between the longitudinal members 18. Thus, the frame 12 forms a segment of a cylinder. The frame 12 has an outer wall 22 and the outer wall 22 corresponding to each of the longitudinal members has a plurality of holes 24 extending into an interior of the frame 12. The holes 24 are spaced apart from each other and are distributed along each of the longitudinal members 18. A plurality of conduits may be positioned within an associated one of the longitudinal members 18 and each of holes 24 may extending into an associated one of the conduits.

A stand 26 is provided and the stand 26 is selectively positioned on a support surface 28 such as ground or the like. The frame 12 is coupled to the stand 26 such that the frame 12 is elevated from the support surface 28. Moreover, the stand 26 is positioned around a garden 30 thereby facilitating the frame 12 to selectively irrigate the garden 30. The garden 30 may be a flower bed or the like.

The stand 26 comprises a plurality of first tubes 32 and each of the first tubes 32 has a first end 34 and a second end 36. The first end 34 corresponding to each of the tubes is fluidly coupled to an associated one of the longitudinal members 18. Additionally, each of the first tubes 32 is positioned proximate an associated one of four corners of the frame 12. The stand 26 includes a plurality of second tubes 38 and each of the second tubes 38 has a primary end 40 and a secondary end 42. The secondary end 42 corresponding to each of the second tubes 38 is closed. Moreover, the primary end 40 corresponding to each of the second tubes 38 insertably receives the second end 36 of an associated one of the first tubes 32. A plurality of plates 44 is provided and each of the plates 44 is coupled to the secondary end 42 of an associated one of the second tubes 38. Each of the plates 44 abuts the support surface 28 when the stand 26 is positioned on the support surface 28.

A plurality of collars 46 is provided and each of the collars 46 is rotatably positioned around an associated one of the second tubes 38. Each of the collars 46 is aligned with the primary end 40 of the associated second tube 38. Additionally, each of the collars 46 is selectively tightened on the associated second tube 38 to frictionally engage the associated first tube 32 at a selected point along the first tube 32. In this way the stand 26 is retained at a selected height. Each of pairs of first 32 and second 38 tubes may have a maximum height of approximately 2.0 meters.

A conduit 48 is fluidly coupled to an associated one of the longitudinal members 18. The conduit 48 extends downwardly within an associated pair of the first 32 and second 38 tubes. A nozzle 50 is coupled to and extends through the associated second tube 38 with respect to the conduit 48. The nozzle 50 is fluidly coupled to the conduit 48 such that the nozzle 50 is in fluid 16 communication with each of the longitudinal 18 and lateral members 20. Moreover, the nozzle 50 is fluidly coupled to the fluid source 14 thereby facilitating the fluid 16 to spray outwardly through the holes 24 in the longitudinal 18 and lateral 20 members. The nozzle 50 may be a hose connection or the like.

A canopy 52 is provided and the canopy 52 is removably positioned on the frame 12. Additionally, the canopy 52 completely covers the frame 12. The canopy 52 is comprised of an opaque material to shade the garden 30 when the canopy 52 is positioned on the frame 12.

In use, the stand 26 is positioned around the garden 30. The stand 26 is adjusted to position the frame 12 at a selected height and each of the collars 46 is tightened to retain the frame 12 at the selected height. The nozzle 50 is fluid 16 coupled to the fluid source 14 and the fluid 16 sprays outwardly from the holes 24. In this way the frame 12 irrigates the garden 30. Additionally, the canopy 52 is selectively positioned on the frame 12 to shade to garden 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to conduit illustrated in the drawings and described in the specification are intended to be encompassed by an embodiment of the disclosure.

Therefore, the foregoing is considered as illustrative only of the principles of the disclosure. Further, since numerous modifications and changes will readily occur to conduit skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. A canopy sprinkler assembly being configured to be positioned over a flower bed thereby shading and selectively irrigating the flower bed, said assembly comprising:
a frame being substantially hollow, said frame being configured to be fluidly coupled to a fluid source thereby facilitating said frame to selectively spray a fluid;
a stand being configured to be positioned on a support surface, said frame being coupled to said stand wherein said frame is configured to be elevated from the support surface, said stand being configured to be positioned around a garden thereby facilitating said frame to selectively irrigate the garden;
a canopy being removably positioned on said frame such that said canopy extends completely over and covers a top and sides of said frame, said canopy being comprised of an opaque material wherein said canopy is configured to shade the garden; and
wherein said frame has a plurality of longitudinal members each extending between a pair of lateral members, said lateral members being spaced apart from each other such that said frame has a rectangular shape, said longitudinal members being spaced apart from each other along said lateral members, each of said lateral members being concavely arcuate between said longitudinal members such that said frame forms a segment of a cylinder.

3. The assembly according to claim 2, wherein said frame has an outer wall, said outer wall having a plurality of holes extending into an interior of said frame, said holes being spaced apart from each other and being distributed on each of said longitudinal and lateral members.

4. The assembly according to claim 2, wherein said stand comprises a plurality of first tubes, each of said first tubes having a first end and a second end, said first end corresponding to one of said first tubes having a conduit being fluidly coupled to an associated one of said longitudinal members, each of said first tubes being positioned proximate an associated one of four corners of said frame.

5. The assembly according to claim 4, further comprising a plurality of second tubes, each of said second tubes having a primary end and a secondary end, said secondary end corresponding to each of said second tubes being closed, said primary end corresponding to each of said second tubes insertably receiving said second end of an associated one of said first tubes.

6. The assembly according to claim 5, further comprising a plurality of plates, each of said plates being coupled to said secondary end of an associated one of said second tubes wherein each of said plates is configured to abut the support surface.

7. The assembly according to claim 5, further comprising a plurality of collars, each of said collars being rotatably positioned around an associated one of said second tubes, each of said collars being aligned with said primary end of said associated second tube, each of said collars being selectively tightened on said associated second tube to frictionally engage said associated first tube at a selected point along said first tube.

8. The assembly according to claim 5, further comprising said conduit extending downwardly within an associated pair of said first and second tubes.

9. The assembly according to claim 8, further comprising a nozzle extending through said associated second tube with respect to said conduit, said nozzle being fluidly coupled to said conduit such that said nozzle is in fluid communication with each of said longitudinal and lateral members, said nozzle being configured to be fluidly coupled to the fluid source thereby facilitating the fluid to spray outwardly through said holes in said longitudinal and lateral members.

10. A canopy sprinkler assembly being configured to be positioned over a flower bed thereby shading and selectively irrigating the flower bed, said assembly comprising:
a frame being substantially hollow, said frame being configured to be fluidly coupled to a fluid source thereby facilitating said frame to selectively spray a fluid, said frame having a plurality of longitudinal members each extending between a pair of lateral members, said lateral members being spaced apart from each other such that said frame has a rectangular shape, said longitudinal members being spaced apart from each other along said lateral members, each of said lateral members being concavely arcuate between said longitudinal members such that said frame forms a segment of a cylinder, said frame having an outer wall, said outer wall having a plurality of holes extending into an interior of said frame, said holes being spaced apart from each other and being distributed on each of said longitudinal and lateral members;
a stand being configured to be positioned on a support surface, said frame being coupled to said stand wherein said frame is configured to be elevated from the support surface, said stand being configured to be positioned around a garden thereby facilitating said frame to selectively irrigate the garden, said stand comprising:
a plurality of first tubes, each of said first tubes having a first end and a second end, said first end corresponding to one of said tubes having a conduit being fluidly coupled to an associated one of said longitudinal members, each of said first tubes being positioned proximate an associated one of four corners of said frame,
a plurality of second tubes, each of said second tubes having a primary end and a secondary end, said secondary end corresponding to each of said second tubes being closed, said primary end corresponding to each of said second tubes insertably receiving said second end of an associated one of said first tubes,
a plurality of plates, each of said plates being coupled to said secondary end of an associated one of said second tubes wherein each of said plates is configured to abut the support surface,
a plurality of collars, each of said collars being rotatably positioned around an associated one of said second tubes, each of said collars being aligned with said primary end of said associated second tube, each of said collars being selectively tightened on said associated second tube to frictionally engage said associated first tube at a selected point along said first tube,
said conduit extending downwardly within an associated pair of said first and second tubes, and
a nozzle extending through said associated second tube with respect to said conduit, said nozzle being fluidly coupled to said conduit such that said nozzle is in fluid communication with each of said longitudinal and lateral members, said nozzle being configured to be fluidly coupled to the fluid source thereby facilitating the fluid to spray outwardly through said holes in said longitudinal and lateral members; and
a canopy being removably positioned on said frame such that said canopy extends completely over and covers a top and sides of said frame, said canopy being comprised of an opaque material wherein said canopy is configured to shade the garden.
